(19) United States
(12) Patent Application Publication
(10) Pub. No.: US 2018/0315411 A1
(43) Pub. Date: Nov. 1, 2018

(54) ACOUSTIC MATERIAL

(71) Applicant: THRACE NONWOVENS & GEOSYNTHETICS S.A., Xanthi (GR)

(72) Inventor: Andreas LAKE, Mt. Pleasant, SC (US)

(73) Assignee: THRACE NONWOVENS & GEOSYNTHETICS S.A., Xanthi (GR)

(21) Appl. No.: 15/967,925

(22) Filed: May 1, 2018

Related U.S. Application Data
(60) Provisional application No. 62/492,563, filed on May 1, 2017.

(51) Int. Cl. G10K 11/168; B32B 7/14; B32B 5/18; B32B 5/02; B32B 27/06; B32B 27/12; B32B 27/32

(52) U.S. Cl. CPC G10K 11/168; B32B 7/14; B32B 5/18; B32B 5/022; B32B 27/065; B32B 2605/00; B32B 27/32; B32B 2323/04; B32B 2323/10; B32B 2307/102; B32B 27/12

(57) ABSTRACT

An acoustic material for sound absorption and dampening includes a scrim layer and a spacer layer. In example forms, the scrim layer includes a micro porous film material and the spacer layer includes a foam material, with the scrim layer being adhered to the spacer layer by laminating the two together. Optionally, the scrim layer includes a melt blown polypropylene or polyethylene. In example embodiments, the melt blown polypropylene or polyethylene can be in the form of a film material or can be directly sprayed on to the spacer layer. Optionally, the scrim layer can further include one or more spun bond layers. In some example embodiments, the spacer layer can be formed from a nonwoven material.

### CROSS-REFERENCE TO RELATED APPLICATION

This application claims the benefit of U.S. Provisional Patent Application Ser. No. 62/492,563 filed May 1, 2017, the entirety of which is hereby incorporated herein by reference for all purposes.

### TECHNICAL FIELD

The present invention relates generally to the field of sound absorbent materials, and more particularly to an acoustic material providing for sound dampening and absorption.

### BACKGROUND

Sound absorbent materials are commonly used in cars, trucks, airplanes, and other transportation vehicles for decreasing or eliminating the effects of exterior noise, primarily engine, exhaust, aerodynamic and tire noise across a wide frequency range. There are many complex noises created within vehicles which change with the driving environment and speed at which the vehicle travels. Commonly, these sound absorbent materials are very heavy and bulky, thereby increasing the weight of the vehicle and/or relying on occupying a large footprint, ultimately increasing the cost of manufacturing and reducing the efficiency of the vehicle. Accordingly, it can be seen that needs exist for improved acoustic or sound dampening materials. It is to the provision of an acoustic material meeting these and other needs that the present invention is primarily directed.

### SUMMARY

In example embodiments, the present invention provides improved acoustic materials. Example forms of the acoustic materials are adaptable to sound absorption applications for transportation vehicles, such as for example, cars, trucks, air planes, marine transportation or other transportation vehicles.

In one aspect, the present invention relates to an acoustic material including a scrim layer and a spacer layer. The scrim layer includes a micro porous film material and the spacer layer includes a foam material. In example embodiments, the scrim layer is adhered to the spacer layer by laminating the two together.

According to some example embodiments, the scrim layer includes a melt blown polypropylene or polyethylene. In example embodiments, the melt blown polypropylene or polyethylene can be in the form of a film material, a nonwoven layer or can be directly sprayed on to the spacer layer. Optionally, the scrim layer can further include one or more spun bond layers. In some example embodiments, the spacer layer can include a nonwoven material or any other light weight high volume material.

In another aspect, the present invention relates to an acoustic material including a scrim layer and a spacer layer laminated together with an adhesive. The adhesive permanently attaches the scrim layer and the spacer layer together, wherein the adhesive material includes at least one opening or passageway such that sound waves are permitted to pass through one of the scrim layer or spacer layer, through the at least one opening or passageway, and within the other of the scrim layer or spacer layer.

In example embodiments, the scrim layer is a micro porous film. In one example embodiment, the scrim layer is a melt blown polypropylene or polyethylene. In example embodiments, the spacer layer is a foam material. In example embodiments, the scrim layer is laminated to the spacer layer by an adhesive, the adhesive being at least partially porous when cured. In example embodiments, the scrim layer is sprayed directly on the spacer layer such that the adhesive is not needed to permanently attach the scrim layer to the spacer layer. In example embodiments, the scrim layer further includes one or more spun bond layers. In example embodiments, the spacer layer includes a nonwoven material. In example embodiments, the scrim layer has a density of between about 5-30 times greater than a density of the spacer layer. In example embodiments, the acoustic material can further include an impermeable film layer applied to the base layer, wherein the impermeable film layer is applied to an opposite side of the base layer than the scrim layer.

In yet another aspect, the present invention relates to an automotive acoustic material including a scrim layer and a spacer layer, the scrim layer having a film material and the spacer layer having a foam material, the film material being about 5-30 times more dense than the foam material, and wherein both the film material and the foam material include at least some porosity such that sound can be absorbed therein.

In example embodiments, the film material is polypropylene or polyethylene. In example embodiments, the scrim layer is a micro porous film. In example embodiments, the scrim layer is a melt blown film. In example embodiments, the scrim layer and spacer layer are laminated together with an adhesive, the adhesive exhibiting a porous structure having one or more openings such that sound is permitted to pass between the scrim layer and spacer layer. In example embodiments, the spacer layer includes a first side and a second side, the first side being generally flat or smooth and the second side comprising one or more ridges and recesses. In example embodiments, the laminated acoustic material including the scrim layer and the spacer layer has a thickness of between about 5 to about 200 millimeters. In example embodiments, the thickness is about 42 millimeters. In example embodiments, the thickness is about 5.1 millimeters.

In another aspect, the present invention relates to an acoustic material including a base layer exhibiting at least some porosity and a spacer layer exhibiting at least some porosity, wherein the base layer and the spacer layer are permanently attached together, wherein the base layer is about 5-30 times the density of the spacer layer, and wherein the thickness of the base layer is less than the thickness of the spacer layer.

In example embodiments, the base layer includes a micro porous film or a melt blown film, the micro porous film or the melt blown film including polypropylene or polyethylene. In example embodiments, the spacer layer includes a porous foam, the porous foam having a substantially smooth first side and a substantially unsmooth second side. In example embodiments, the base layer and spacer layer are attached together by an adhesive, the adhesive having a porous structure.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 shows a front perspective view of an acoustic material according to a first example embodiment of the present invention.

FIG. 2 shows a detailed perspective view of the acoustic material of FIG. 1.

FIG. 3 show a bottom surface of the acoustic material of FIG. 1.

FIG. 4 shows a perspective view of an acoustic material according to another example embodiment of the present invention.

FIG. 5 shows a detailed perspective view of the acoustic material of FIG. 4.

FIG. 6 shows a perspective view of an acoustic material according to another example embodiment of the present invention.

FIG. 7 shows a cross-sectional view of the acoustic material of FIG. 6 taken along line 7-7.

FIG. 8 shows a cross-sectional view of an acoustic material according to another example embodiment of the present invention.

FIG. 9 shows a vehicle wheel house having an acoustic material applied thereto according to another example embodiment of the present invention.

FIG. 10 shows a vehicle underbody shield having an acoustic material applied thereto according to another example embodiment of the present invention.

FIG. 11 shows an engine compartment shield having an acoustic material applied thereto according to another example embodiment of the present invention.

FIG. 12 shows a vehicle firewall having an acoustic material applied thereto according to another example embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

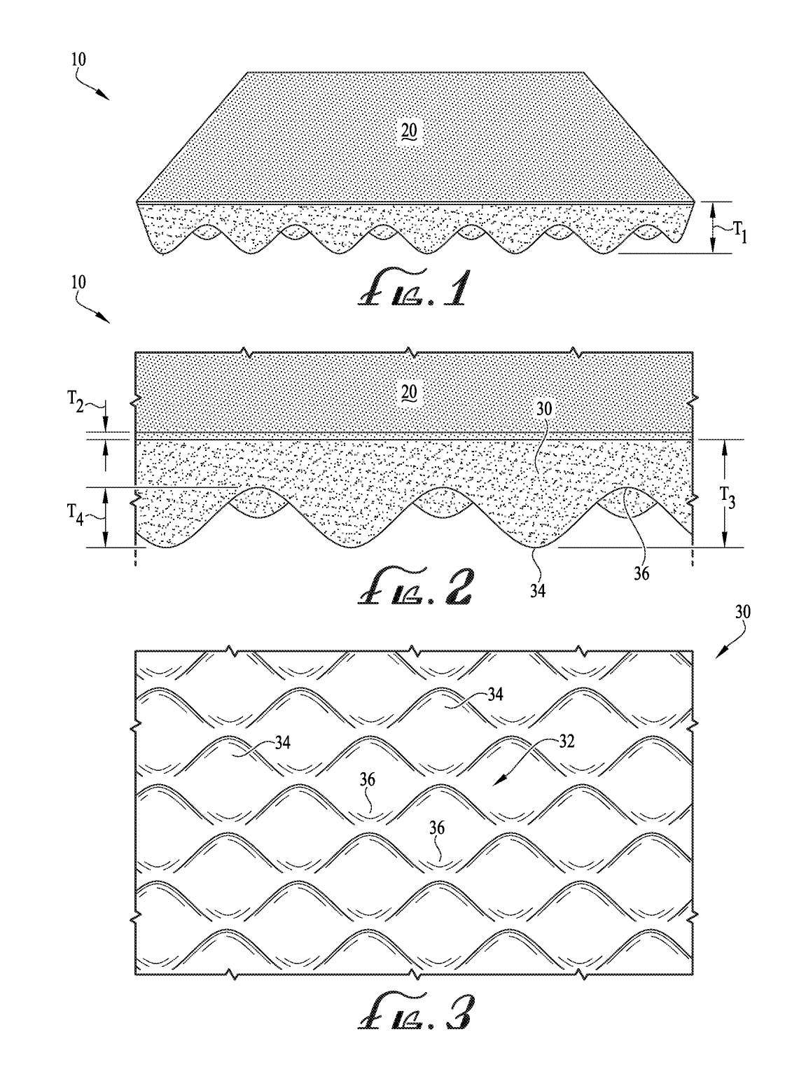

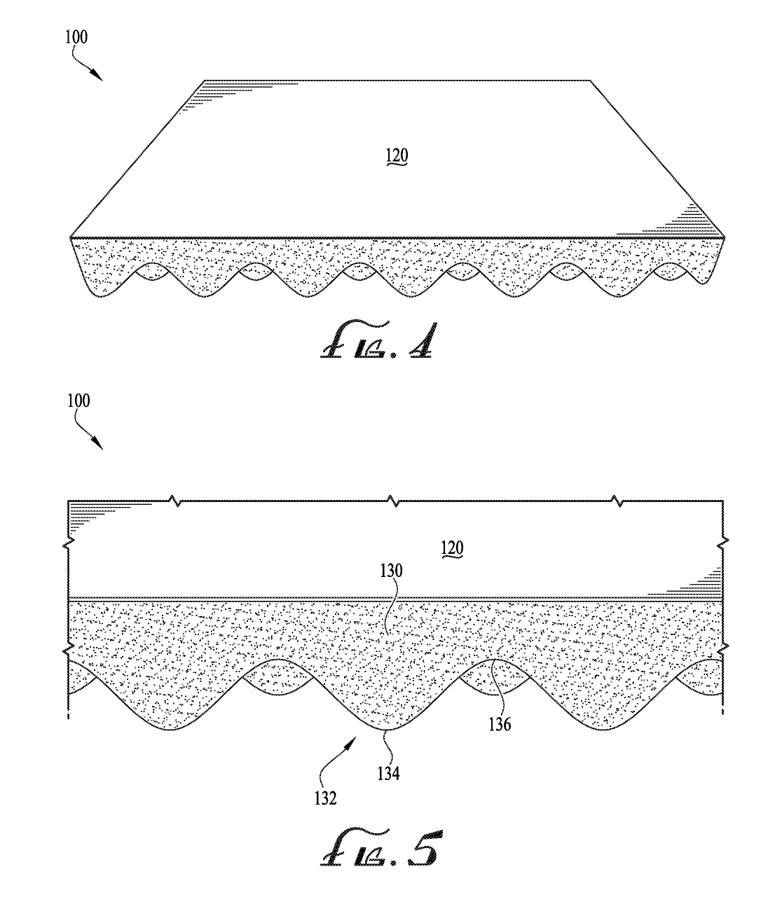

With reference now to the drawing figures, wherein like reference numbers represent corresponding parts throughout the several views, FIGS. 1-3 show an acoustic material 10 according to an example embodiment of the present invention. The acoustic material 10 generally comprises a scrim layer 20 and a spacer layer 30. The scrim layer 20 overlies at least one side (top or bottom) of the spacer layer 30. In the depicted example embodiment, the scrim layer 20 is applied to a top flat side of the spacer layer 30. As depicted in FIGS. 2-3, the spacer layer 30 is generally formed from a light weight porous foam material. According to example embodiments, one side of the foam is substantially flat or smooth and the other side of the foam comprises one or more ridges 34 and recesses 36 (e.g., some type of structure or dimples) to provide for an absorptive surface that minimizes reflection of sound therefrom. In other example embodiments, the one or more sides of the spacer layer 30 comprises a plurality of channels, grooves, or otherwise define one or more voids or other impressions and/or projections to provide at least some irregularity in the surface thereof, for example, to improve the absorptive properties thereof and to minimize the sound reflection.

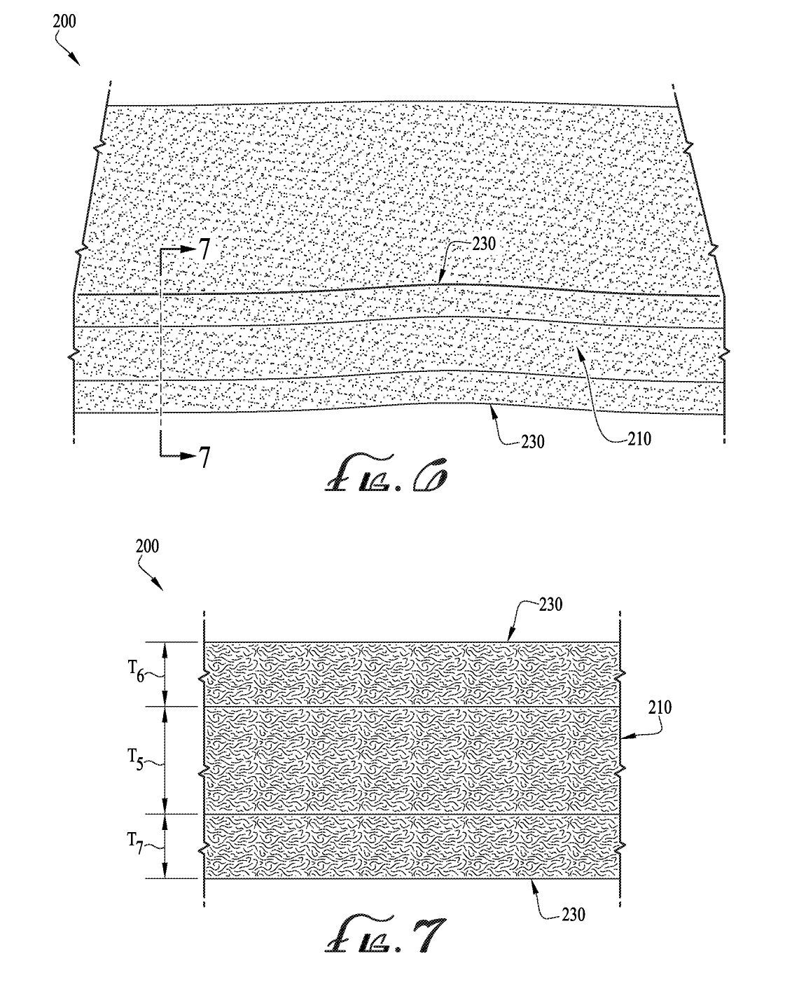

In example embodiments, the scrim layer 20 can comprise a micro porous film (as depicted in FIGS. 1-2), or can comprise a sheet or film formed from melt blown polypropylene (PP), polyethylene (PE) or thermoplastic polyurethane (TPU) (see FIGS. 4-5). Optionally, spun bond layers can be provided with the scrim layer 20 in addition to either of the micro porous film or the melt blown film. In example embodiments, for example, when the scrim layer 20 is in the form of a micro porous film, the scrim layer 20 is generally laminated with the spacer layer 30, for example, to adhere the scrim layer 20 to the spacer layer 30. In example embodiments, the lamination process provides for attachment of the scrim layer 20 and spacer layer 30 by an adhesive, for example, a spray glue or other spray adhesive. In example embodiments, the adhesive is preferably structured such that when set and with the scrim layer 20 and spacer layer 30 being attached together, a plurality of openings, conduits and/or channels are defined within the adhesive (and extending therethrough) such as to define a open porous bonding structure. Accordingly, according to example embodiments, the adhesive preferably provides attachment of the scrim layer 20 to the spacer layer 30 while exhibiting an open porous structure so as to permit sound that is absorbed within the scrim layer 20 to pass through the open porous adhesive structure, for example, such that the sound can further be absorbed and dissipated in the spacer layer 30, thereby permitting maximum sound absorption and further dissipation of the sound waves.

In alternate example embodiments, the melt blown material can be directly sprayed (with or without the spun bond layers) on the top flat side of the spacer layer 30, for example, wherein the melt blown material is configured for attachment to the spacer layer 30. Thus, according to some example embodiments, an adhesive material is not needed whereby the scrim layer 20 comprises a melt blown material which is sprayed on the spacer layer 30. In example embodiments where the melt blown material is sprayed on the spacer layer 30, the melt blown material is preferably at least partially porous and comprises at least one opening, channel, conduit or other void such that sound is absorbable entirely therethrough and within the spacer layer 30. In some example embodiments, the melt blown material can be in the form of a sheet or film (see FIGS. 4-5), and wherein the lamination provides for adhesion of the melt blown film with the top flat side of the spacer layer 30, for example, by providing an adhesive comprising an open porous structure to facilitate sound waves passing through the scrim layer and within the spacer layer 30. In alternate example embodiments, other lamination or bonding processes such as heat, pressure, welding, adhesives and/or combinations thereof can be used and are within the scope of the present invention.

In example embodiments, the micro porous film comprises a density of between about 100 kg/m³-2000 kg/m³. In example embodiments, the melt blown film comprises a density of between about 300 kg/m³-1200 kg/m³. In example embodiments, for example, when the melt blown material is intended to be sprayed on the spacer layer 30 rather than it being in the form of a film, the density of the melt blow spray is generally between about 300 kg/m³-1200 kg/m³.

In example embodiments, the spacer layer 30 comprises a substantially porous light weight foam comprising a low specific weight. In example embodiments, the density and indentation load deflection (ILD) value of the foam can be chosen as desired. According to example embodiments, the density of the spacer layer can be between about 10 kg/m³-800 kg/m³. Preferably, the foam spacer layer 30 is substantially less dense relative to the density of the scrim layer 20. For example, according to one example embodiment, the scrim layer 20 density is between about 5-30 times greater than the spacer layer density. In alternate embodiments, the spacer layer 30 can comprise other foams, nonwoven materials, glass fiber products, a grid (formed from foam, nonwovens, glass fiber, etc.), or other light weight materials as desired. According to some example embodiments, the spacer layer 30 comprises polyethylene (PE), polyurethane (PU), polyurethane theraphalate (PET) or nylon, or other known synthetic and/or natural materials, and/or combinations thereof.

Referring to FIGS. 1-2, the acoustic material 10 generally comprises an overall thickness T1 of between about 10-200 millimeters (e.g., 0.3937 in-7.8740 in), for example, wherein a thickness T2 of the scrim layer 20 can be between about 0.1-100 millimeters (e.g., 0.0004 in-3.9370 in) and a thickness T3 of the spacer layer 30 can be between about 5-100 millimeters (e.g., 0.19685 in-3.9370 in). According to one example embodiment, the overall thickness T1 of the material 10 is about 42 millimeters (e.g., 1.65 in) with the thickness T2 being about 2 millimeters (e.g., 0.08 in) and the thickness T3 being about 40 millimeters (e.g., 1.57 in). According to another example embodiment, the overall thickness T1 of the material is about 5.1 millimeters, the thickness T2 is about 0.1 millimeters and the thickness T3 is about 5 millimeters. In alternate embodiments, the thicknesses T1, T2, T3 can be chosen as desired.

As depicted in FIG. 2, the spacer layer 30 comprises a foam material having a substantially flat top side and a structured bottom side or surface 32. According to example embodiments, the structured bottom surface 32 comprises the plurality of ridges 34 and recesses 36 (see FIG. 3), which are generally uniformly distributed along the surface 32. In example embodiments, a dimension T4 is defined between the outermost portion of the ridge 34 and the innermost portion of the recess 36. In example embodiments, the dimension T4 is generally between about 2-30 millimeters (e.g., 0.0787 in-1.1811 in). In example embodiments, the dimension T4 is at least large enough such that sound waves are substantially absorbed within the surface 32 rather than being reflected therefrom. According to some example embodiments, a spacer layer comprising a plurality of openings (extending entirely through the spacer layer 30) can be utilized, for example, wherein the openings define a grid-like pattern or matrix of openings along the bottom surface. In example embodiments, the structured surface 32 (whether comprising ridges and recess, dimples, openings, channels, grooves, pathways or other surface features) preferably provides for an adequate space to sufficiently absorb and dampen the sound waves within the spacer.

FIGS. 4-5 show an acoustic material 100 according to another example embodiment of the present invention. In example embodiments, the acoustic material 100 is substantially similar to the acoustic material 10, for example, which comprises a scrim layer and a spacer layer. In example embodiments, the acoustic material 100 comprises a scrim layer 120 and a spacer layer 130. In example embodiments, the scrim layer 120 comprises a melt blown sheet or film material (e.g., generally either formed from PP, PE and/or TPU), and the spacer layer 130 comprises a light weight porous foam material. According to example embodiments, the scrim layer 120 is generally laminated (e.g., adhesive or other adhering compound) with the spacer layer 130 to provide for permanent attachment of the scrim layer 120 to the spacer layer 130. Optionally, as described above, rather than laminating the melt blown film scrim layer 120 to the spacer layer 130, the melt blown scrim layer 120 can be directly sprayed on to the spacer layer 130. Optionally, the melt blown scrim layer (either in the form of a film or spray) can further be combined with spun bond layers. According to one example embodiment, the spun bond layers are formed from polypropylene (PP) and can be applied on one or both sides of the melt blown or micro porous film scrim layer, for example, which can have a weight between about 15-100 gsm. As described above and according to one example embodiment, the adhesive preferably provides attachment of the scrim layer 120 to the spacer layer 130 while exhibiting an open porous structure so as to permit sound that is absorbed within the scrim layer 120 to pass through the open porous adhesive structure, for example, such that the sound can further be absorbed and dissipated in the spacer layer 130, thereby permitting maximum sound absorption and further dissipation of the sound waves. Further, in example embodiments where the melt blown material is sprayed on the spacer layer 130 (and functions as the scrim layer 120), the melt blown material is preferably at least partially porous and comprises at least one opening, channel, conduit or other void such that sound is absorbable entirely therethrough and within the spacer layer 130.

In example embodiments, the acoustic materials 10, 100 as described herein can be used for a plurality of purposes, most preferably for sound dampening and noise absorption. In example embodiments, the acoustic materials 10, 100 are preferably substantially light weight and provide at least the same (if not better) sound absorption qualities exhibited by known sound absorbent materials. Preferably, by being lighter in weight than known sound absorbent materials, the acoustic materials 10, 100 increase the efficiency of the transportation vehicle (e.g., lighter weight=less energy required to move vehicle) and reduce costs. According to example embodiments, the acoustic materials 10, 100 can be used in a vehicle door panel, floor board, ceiling component(s), aircraft fuselage, boat hulls, etc. According to example embodiments, significant noise reductions of the sound absorption coefficient over 1 can be achieved by using one or more of the acoustic materials 10, 100.

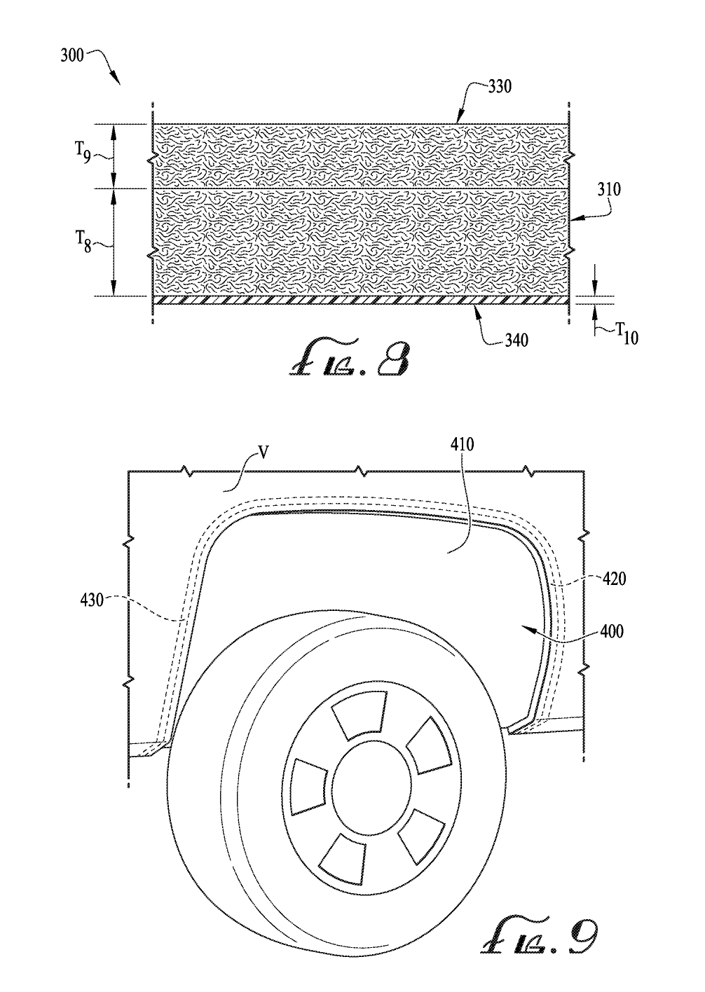

According to another example embodiment, the present invention relates to an acoustic material 200 (see FIGS. 6-7). In example embodiments, the material 200 comprises a base layer 210 and a fiber cap layer 230 applied to one or each side of a base layer 210. As depicted, the material 200 comprises a scrim or base layer 210 sandwiched between fiber cap layers 230 or only one layer 230. As depicted in FIG. 7, the scrim or base layer 210 comprises a thickness T5, a first fiber cap layer 230 comprises a thickness T6, and a second fiber cap layer 230 comprises a thickness T7. According to one example embodiment, the scrim or base layer 210 comprises a density of about 3 ounces per square yard (oz/yd²) of material and the first and second fiber cap layers 230 comprise a density of about 0.5 ounce per square yard (oz/yd²) of material. As such, the thickness T5 of the scrim or base layer 210 is about 61 mil (e.g., 0.061 inch) and the thicknesses T6, T7 of the fiber cap layers 230 are about 5 mil (e.g., 0.005 inch). According to another example embodiment, the scrim or base layer 210 comprises a density of about 42 ounces per square yard (oz/yd²) of material and the fiber cap layers 230 comprise a density of about 3 ounces per square yard (oz/yd²) of material. Thus, the scrim or base layer 210 comprises a thickness T5 of about 244 mil (e.g., 0.244 inch) and the fiber cap layers 230 comprise thicknesses T6, T7 of about 26 mil (e.g., 0.026 inch). U.S. patent application Ser. No. 15/335,720 is incorporated by reference herein in its entirety and discloses a plurality of materials from which the acoustic material 200 can be formed. In example embodiments, the thicknesses T5, T6 and T7 are generally based upon pre-molded thicknesses, for example, wherein the layers are generally placed atop each other prior to being molded. According to example embodiments, the final overall thickness (T5+T6+T7) can vary substantially depending on the particular application. In example embodiments, the final overall thickness can generally be between about 2-8 millimeters. According to one example embodiment, when the acoustic material is being using for a wheelhouse liner application, the thickness is generally between about 2.5-3.5 millimeters.

In example embodiments, the invention includes a material formed as described, comprising a double layer (scrim or base layer, and fiber cap layer), with the fiber cap layer forming a glue or adhesive coating on one side of the material for attachment or bonding of the material to various components (for example automotive components) or other materials. In alternate forms, a three layer or two layer material can be formed by providing a fiber cap layer on both sides of the scrim or base layer, for example, as depicted in FIGS. 6-7.

According to some example embodiments, the scrim layer as described in the embodiments above comprises a micro porous film. In example embodiments, the micro porous film (e.g., when used as a scrim layer) comprises a combination of polypropylene and/or polyethylene with calcium carbonate (CaCO3), for example, to provide a film with a high water vapor transmission rate. In example embodiments, the micro porous film is soft, flexible and comprises a high tensile strength with high air and water vapor transmission rates (WVTR) while also being impermeable to liquids, for example, such as water. According to one example embodiment, the film is prepared by stretching a blown extruded composition of polyolefin and high levels of calcium carbonate in one direction from 2 to 4 times to reach water vapor transmission rate values over 800 g/m²/day.

In example embodiments, the micro porous film is breathable and is manufactured by a machine direction orientation (MDO) process to induce breathability with a high WVTR. According to one example embodiment, the micro porous film is breathable and comprises 50%-60% by weight of surface modified calcium carbonate having a particle size generally less than 25 micrometers. In another example embodiment, the micro porous film comprises 35%-45% by weight of random copolymer and/or homopolymer polypropylene. In some example embodiments, the micro porous film comprises 1%-5% by weight of materials for UV light resistance, heat stabilization and color masterbatch.

According to another example embodiment, the scrim layer as described in the embodiments above comprises a polypropylene (PP)/calcium carbonate (CaCO3) compound. In example embodiments, the polypropylene (PP)/calcium carbonate (CaCO3) compound comprises a density of about 1.5 g/cm³, a melt flow index (MFI) of between about 1.5 g-3 g/10 min, and the moisture content before extrusion is generally less than about 1500 ppm. According to alternate example embodiments, the density, melt flow index and moisture content before extrusion can be chosen as desired. In example embodiments, a stretching process is provided wherein the film passes through a sequence of heated rollers. According to one example embodiment, the process includes four steps including 1) preheating (the film enters in the machine direction orientation (MDO), 2) orienting (the film is nipped between a slow and a fast rotating roller at a desired draw ratio), 3) annealing (thermal stability is induced into the film by quenching and annealing after orientation), and 4) cooling (the film is cooled to near ambient temperature). In example embodiments, the stretching of the film in the machine direction leads to detachment of the CaCO3 particles from the polyolefin matrix which induces micro holes and thus porosity. The lower the stretching temperature, the higher the breathability. Stretching conditions generally affect the strength, the film's elongation and thermal stability. In example embodiments, the stretching temperature and conditions can be chosen as desired to produce the film with desirable characteristics.

According to another example embodiment, the acoustic material 200 can be modified so as to provide a sound reflection layer so as to improve the sound transmission loss, thereby further reducing the ability of sound to further transmit from the acoustic material once being absorbed thereby. For example, as depicted in FIG. 8, the acoustic material 300 comprises a scrim or base layer 310, a first fiber cap layer 330 laminated to one side of the scrim or base layer 310, and a sound reflection layer or film 340 laminated to the other side of the base layer 310. In example embodiments, the film 340 comprises a substantially impermeable or 100% airflow resistant film, for example, so as to prevent sound from passing therethrough. In example embodiments, the film 340 can comprise polypropylene (PP), polyethylene (PE), polyamide (PA), thermoplastic polyurethane (TPU) or other materials or combinations thereof as desired. For example, according to one example embodiment, a thermoplastic elastomer, for example, such as thermoplastic polyurethane, can be layered or applied as a melt blown layer (or optionally as a film or sheet), for example, so as to act as the sound reflection layer 340.

In example embodiments, the film 340 functions as a sound reflection layer so as to cause any sound waves passing through the base layer 310 and fiber cap layer 330 to reflect, for example, and be projected back within the base layer 310 and fiber cap layer 330. Thus, according to example embodiments, the film 340 functions as a sound reflection layer, is applied to one side of the base layer 310, and can substantially improve sound transmission loss and therefore improve the effectiveness of the acoustic material 300. According to one example embodiment, the scrim or base layer 310 comprises a density of about 3 ounces per square yard (oz/yd²) of material and the fiber cap layer 330 comprises a density of about 0.5 ounce per square yard (oz/yd²) of material. As such, the thickness T8 of the scrim or base layer 310 is about 61 mil (e.g., 0.061 inch) and the thickness T9 of the fiber cap layer 330 is about 5 mil (e.g., 0.005 inch). According to another example embodiment, the scrim or base layer 310 comprises a density of about 42 ounces per square yard (oz/yd²) of material and the fiber cap layer 330 comprise a density of about 3 ounces per square yard (oz/yd²) of material. Thus, the scrim or base layer 310 comprises a thickness T8 of about 244 mil (e.g., 0.244 inch) and the fiber cap layer 330 comprise thicknesses T9 of about 26 mil (e.g., 0.026 inch). In example embodiments, the film 340 can comprise a density of between about 0.125-10 ounces per square yard (oz/yd²) of material and comprise a thickness T10 of between about 0.1 mil (e.g., 0.0001 inch) to about 40 mil (e.g., 0.04 inch). Optionally, according to other example embodiments, the layers 310, 330 and 340 can comprise a desired density and thickness.

According to example embodiments, the acoustic materials as described herein can preferably be adaptable to transportation or automotive applications, for example, to be applied or fitted to one or more components of transportation vehicles or automobiles so as to enhance sound absorption. For example, when applied to vehicle components, road noise or other sounds or noises attributed to vehicular transportation can be eliminated to provide a much quieter cabin or internal compartment or space for the driver and/or passenger.

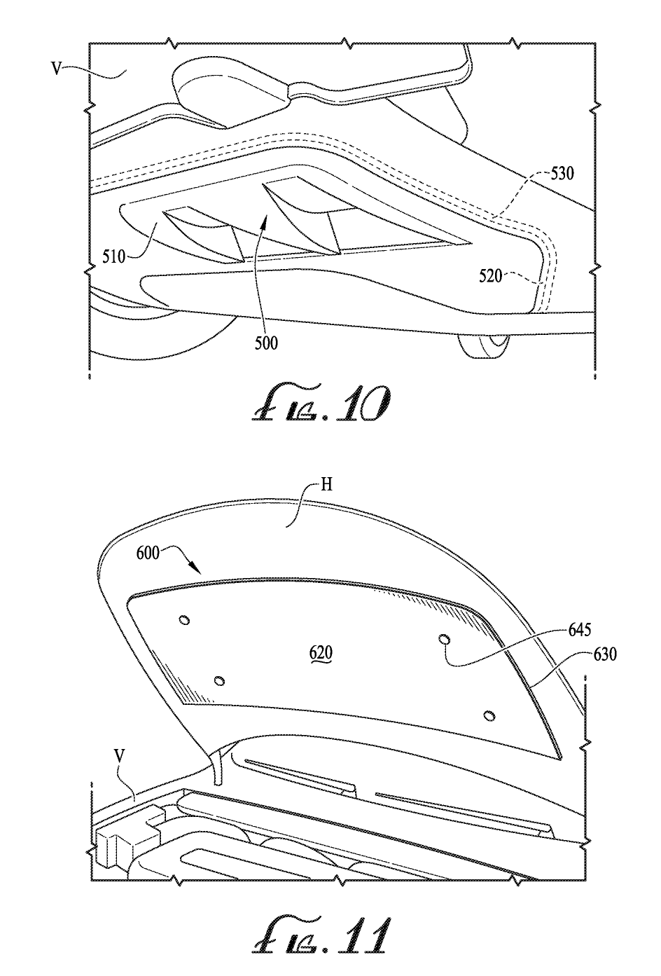

FIGS. 9-12 show the acoustic material applied to a vehicle according to some example embodiments of the present invention. For example, as shown in FIG. 9, a vehicle V wheel house 400 comprises a wheel house liner 410 and an acoustic material applied to the rear side thereof, for example, behind the wheel house liner 410. In example embodiments, the acoustic material comprises at least one scrim layer 420 laminated with at least one base layer 430. According to another application, an under carriage 500 of the vehicle V comprises an underbody shield 510 and an acoustic material applied to a rear side thereof, for example, behind the underbody shield 510 (see FIG. 10). In example embodiments, the acoustic material comprises at least one scrim layer 520 laminated with at least one base layer 530. According to additional example embodiments, an acoustic material can be applied to an engine compartment shield 600, a vehicle's V firewall 700, or other various components, framing members, panels, etc. of an automobile and/or other transportation vehicles (e.g., train, bus, airplane, boat, etc.).

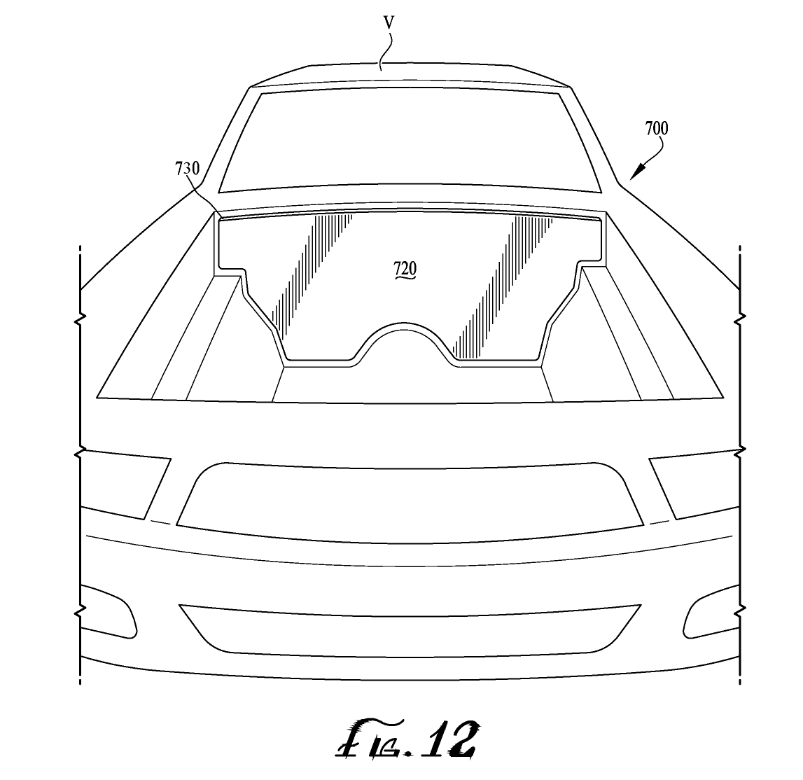

As depicted in FIG. 11, the engine compartment shield 600 mounted to the underside of the hood H and generally is secured therewith with one or more clips, couplings or fasteners 645. In example embodiments, the shield 600 comprises an acoustic material comprising at least one scrim layer 620 laminated with at least one base layer 630. In example embodiments, the scrim layer 620 is generally exposed and faces the engine of the vehicle V when the hood H is closed. Thus, the base layer 630 is generally configured to be positioned against the interior surface of the hood H. As depicted in FIG. 12, an acoustic material is attached to the firewall 700 of the vehicle, for example, on an exterior portion of the firewall and with the scrim layer 720 generally exposed and facing the engine compartment. The base layer 730 is positioned against an external surface of the firewall 700. Preferably, one or more adhesives, glues, or other clips and/or fasteners can be used for mounting the acoustic material to the firewall 700 of the vehicle.

In optional example embodiments and with reference to the acoustic material and vehicle applications, the scrim and base layers can optionally be reversed, for example, such that the base layer is applied against the vehicle component with the scrim layer being permanently attached on the other side of the base layer. Optionally, one or more additional layers, films, and/or other materials can be applied to the acoustic material and/or vehicle components as desired. Optionally, as depicted in FIGS. 11-12, the base layer can be exposed to the engine such that the scrim layer is seated against the interior surface of the hood H and exterior surface of the firewall 700.

In other forms, the invention includes a material formed as described, comprising a smooth film or surface formed from the fiber cap layer on at least one side of the scrim or base layer, to resist mud or snow buildup on the material. Optionally, a thermoplastic polyurethane (TPU) film layer can be directly laminated to the base layer. Optionally, the material is heat resistant to at least 110° C., 180° C., or 220° C., and/or is recyclable and/or formed of one or more recycled components. According to some example embodiments, the fiber cap layer can provide a closed surface to reflect sound (e.g., tire/road noise) and the base layer provides for the absorption of sound.

While the invention has been described with reference to example embodiments, it will be understood by those skilled in the art that a variety of modifications, additions and deletions are within the scope of the invention, as defined by the following claims.

What is claimed is:

1. An acoustic material comprising a scrim layer and a spacer layer laminated together with an adhesive, the adhesive permanently attaching the scrim layer and the spacer layer together, the adhesive material comprising at least one opening or passageway such that sound waves are permitted to pass through one of the scrim layer or spacer layer, through the at least one opening or passageway, and within the other of the scrim layer or spacer layer.

2. The acoustic material of claim 1, wherein the scrim layer comprises a micro porous film.

3. The acoustic material of claim 1, wherein the scrim layer comprises a melt blown polypropylene or polyethylene.

4. The acoustic material of claim 1, wherein the spacer layer comprises a foam material.

5. The acoustic material of claim 2, wherein the scrim layer is laminated to the spacer layer by an adhesive, the adhesive being at least partially porous when cured.

6. The acoustic material of claim 3, wherein the scrim layer is sprayed directly on the spacer layer such that the adhesive is not needed to permanently attach the scrim layer to the spacer layer.

7. The acoustic material of claim 1, wherein the scrim layer further comprises one or more spun bond layers.

8. The acoustic material of claim 1, wherein the spacer layer comprises a nonwoven material.

9. The acoustic material of claim 1, wherein the scrim layer comprises a density of between about 5-30 times greater than a density of the spacer layer.

10. The acoustic material of claim 1, further comprising an impermeable film layer applied to the base layer, the impermeable film layer being applied to an opposite side of the base layer than the scrim layer.

11. An automotive acoustic material comprising a scrim layer and a spacer layer, the scrim layer comprising a film material and the spacer layer comprising a foam material, the film material being about 5-30 times more dense than the foam material, and wherein both the film material and the foam material comprise at least some porosity such that sound can be absorbed therein.

12. The automotive component of claim 11, wherein the film material comprises polypropylene or polyethylene.

13. The automotive acoustic material of claim 11, wherein the scrim layer comprises a micro porous film.

14. The automotive acoustic material of claim 11, wherein the scrim layer comprises a melt blown film.

15. The automotive acoustic material of claim 11, wherein the scrim layer and spacer layer are laminated together with an adhesive, the adhesive exhibiting a porous structure comprising one or more openings such that sound is permitted to pass between the scrim layer and spacer layer.

16. The automotive acoustic material of claim 11, wherein the spacer layer comprises a first side and a second side, the first side being generally flat or smooth and the second side comprising one or more ridges and recesses.

17. The automotive acoustic material of claim 11, wherein the laminated acoustic material comprising the scrim layer and the spacer layer comprises a thickness of between about 5 to about 200 millimeters.

18. The automotive acoustic material of claim 17, wherein the thickness is about 42 millimeters.

19. The automotive acoustic material of claim 17, wherein the thickness is about 5.1 millimeters.

20. An acoustic material comprising:
a base layer exhibiting at least some porosity; and
a spacer layer exhibiting at least some porosity,
wherein the base layer and the spacer layer are permanently attached together, wherein the base layer is about 5-30 times the density of the spacer layer, and wherein the thickness of the base layer is less than the thickness of the spacer layer.

21. The acoustic material of claim 20, wherein the base layer comprises a micro porous film or a melt blown film, the micro porous film or the melt blown film comprising polypropylene or polyethylene.

22. The acoustic material of claim 20, wherein the spacer layer comprises a porous foam, the porous foam comprising a substantially smooth first side and a substantially unsmooth second side.

23. The acoustic material of claim 20, wherein the base layer and spacer layer are attached together by an adhesive, the adhesive comprising a porous structure.
